(19) United States
(12) Patent Application Publication
(10) Pub. No.: US 2023/0405651 A1
(43) Pub. Date: Dec. 21, 2023

(54) SYSTEM AND METHOD FOR PROCESSING OF MIXED SOLID WASTE TO RECOVER RECYCLABLE MATERIALS

(71) Applicant: Paul W Alford, Holden, LA (US)

(72) Inventor: Paul W Alford, Holden, LA (US)

(21) Appl. No.: 18/211,565

(22) Filed: Jun. 19, 2023

Related U.S. Application Data
(60) Provisional application No. 63/353,841, filed on Jun. 21, 2022.

(51) Int. Cl. B09B 3/35; B09B 3/45; B03C 1/23; B03C 1/30; B03B 9/06

(52) U.S. Cl. CPC B09B 3/35; B09B 3/45; B03C 1/23; B03C 1/30; B03B 9/06; B03C 2201/20; B09B 2101/85

(57) ABSTRACT

A system for recovering recyclable materials from mixed waste is provided. The system processes existing municipal solid waste collections to recover recyclable materials from the waste. The system uses various separation processes sequenced with a rotating, horizontal constant-flow steam based waste processing vessel to efficiently separate high value materials such as metals and rigid plastics while additionally separating low value plastics and post-consumer commodities. The system reduces landfill load and operational costs while simultaneously providing the reduction of carbon emissions achieved with recycling post-consumer commodities.

### PRIORITY

The present application claims the benefit of U.S. Provisional Application Ser. No. 63/353,841, filed Jun. 21, 2022, which is herein incorporated by reference in its entirety.

### THE FIELD OF THE INVENTION

The present invention relates to processing waste. In particular, examples of the present invention relate to a system for processing mixed household municipal solid waste to separate recyclable materials from a mixed post-consumer waste stream and facilitate recycling of these materials without source separation and additional, separate transportation.

### INTRODUCTION

Widespread adoption of consumer recycling has been hindered by several difficulties. Many source separated, “curbside” recycling programs have difficult to understand restrictions on what can be recycled and what cannot be recycled. Many areas do not offer curbside recycling due to the increased cost of operating such a program and there are many instances where source separated post-consumer recycling collections have ended up in landfills when commodity values have dipped below profitable levels for curbside materials recovery facility (MRF) operators. Many consumers do not participate in recycling programs due to the added difficulty in separating recyclable materials from household waste and/or having to transport these materials to a remote collection point when curbside collection is not available.

### BRIEF DESCRIPTION OF THE DRAWINGS

Non-limiting and non-exhaustive examples of the present invention are described with reference to the following figures, wherein like reference numerals refer to like parts throughout the various views unless otherwise specified.

FIG. 1 is a schematic diagram which illustrates a first section of a waste processing system.

FIG. 2 is a schematic diagram which illustrates a second section of the waste processing system.

Corresponding reference characters indicate corresponding components throughout the several views of the drawings. Unless otherwise noted, the drawings have not been drawn to scale and in some cases equipment described in one embodiment might be duplicated to match operating system flow and/or to maximize separations/recovery efficiency. Skilled artisans will appreciate that elements in the figures are illustrated for simplicity and clarity. For example, the dimensions of some of the elements in the figures may be exaggerated relative to other elements to help improve understanding of various examples of the present invention. Also, common but well-understood elements that are useful or necessary in a commercially feasible embodiment are often not depicted in order to facilitate a less obstructed view of these various embodiments of the present invention.

It will be appreciated that the drawings are illustrative and not limiting of the scope of the invention which is defined by the appended claims. The examples shown each accomplish various different advantages. It is appreciated that it is not possible to clearly show each element or advantage in a single figure, and as such, multiple figures are presented to separately illustrate the various details of the examples in greater clarity. Similarly, not every example need accomplish all advantages of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the above disclosure, reference has been made to the accompanying drawings, which form a part hereof, and in which are shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples. It is appreciated that the figures provided herewith are for explanation purposes to persons ordinarily skilled in the art.

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be a significant digit above or below the number or endpoint. For example, “about 5” refers to a value that could be 4, 5, or 6.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

As post-consumer waste recycling continues to evolve primarily around “source separated”, curbside collection with recyclables bound for curbside materials recovery facilities (MRFs), it has become apparent that high labor, utility and capital costs, separate collection and transport costs, fluctuating recyclable commodities value, difficult to understand curbside program recyclable and non-recyclable commodity lists and widespread public apathy have resulted in more recyclable materials being landfilled than recycled. With current higher awareness of the negative impacts of carbon emissions on the environment, recovery and reuse of recyclables from landfill bound municipal solid waste (MSW) could and should emerge into a critically important role in reducing these harmful environmental impacts. Well intended extended producer responsibility (EPR) legislation has moved slowly forward on a State-by-State level but unfortunately, massive increases in the production of plastics are occurring, with accelerated higher production of these recyclable materials far outpacing current growth in the recycling sector.

Current efforts to recycle materials from MSW are limited to very few materials and often result in inefficient uses of the materials. For example, there are some “Dirty MRF” facilities which primarily recover ferrous metals and sometimes non-ferrous metals from MSW. Other recyclable materials such as plastics, paper or paperboard are typically discarded or densified for use as fuel in cement kilns or waste to energy facilities rather than recycling these materials, with plastics and some inorganic components becoming a major source of non-renewable carbon emissions containing numerous hazardous inorganic contaminants.

The present disclosure presents a unique system for processing landfill bound MSW to recover most recyclable materials from the MSW and represents a more cost-effective and more efficient approach to post consumer recycling. Because the system utilizes existing MSW collection infrastructure, it results in recovery of nearly all recyclable materials, as opposed to source separation which many families either have no access to, or simply choose to not participate in due to high cost or apathy. The system is economically viable and is capable of operation without the significant subsidies, mandated participation or implementation of deposit legislation, which are often required to support existing recycling operations. The landfill bound MSW recycling system will not only open the door to meaningful recovery of massive quantities of recyclables without requiring access to curbside programs but will also result in recovery and recycling of items typically not allowed at curbside programs, such as film plastics and low value rigid plastics which often represent as much as 70% of post-consumer plastics and a USEPA estimated 14% of all MSW landfilled. The system additionally performs landfill-based separation of electronic waste (e-waste), batteries, textiles, glass, and further development of organics digestion. Initial separation of these commodities enhances downstream commodity separations efficiency, facilitates future processing where commodity recycling is already emerging, and creates economies of scale as facility economic sustainability is facilitated by numerous synergistic income streams. Although the present disclosure of the MSW commodity recycling approach is frequently compared to source separated, curbside recyclable recovery in this document, this system is complimentary to curbside programs in accelerating and maximizing commodity recovery overall. The systems will typically be more valuable for landfills without curbside recycling access, as commodity recovery (and associated profit) will be much higher in these un-serviced markets. Such systems will also recover numerous additional low value commodities for recycling such as textiles, film plastics, lower value rigid plastics and glass, and high value yet problematic materials such as lithium batteries and e-waste, which are commonly quite unwelcome within curbside programs. Curbside MRFs could also benefit as this system can provide economic processing of curbside MRF residuals which are currently sent to MSW landfills for disposal. Source separated curbside residuals commonly contain a much higher ratio of recyclable commodities and less contamination than typical household MSW and can be economically processed by the present system.

Another benefit provided by this system is the temporary deferral of development of systems to pre-process waste collected in large community dumpsters (non-curbside mixed waste) and other large, centralized collections as these recycling locations nearly always result in inappropriate dumping of construction debris, yard waste, household hazardous waste, furniture, appliances and other unintended goods. Removal of such materials is costly and typically leads to the need for shredding and more extensive early separations.

The system improves overall recycling efficiency and lowers overall separations and recycling cost while adding numerous new value streams and increasing total revenues within a circular economy based recycling program. The system is capable of early removal of significant quantities of municipal waste prior to steam processing while creating economies of scale for multiple traditional recycle commodities. The system allows for long term, sustainable profitability by utilizing existing collection infrastructure and combining recovery of large quantities of numerous post-consumer commodities of high value with recovery of numerous low-value post-consumer commodities currently ignored, at a single landfill-based location. Further on-site development of recycling technology for low-value or zero-value materials separated from MSW is critically important to maximum landfill diversion and overall decarbonization efforts as the value of low carbon recovered commodities is realized by replacement of virgin materials in the manufacture of recycled products. The waste processing system includes systems that separate low value plastics and textiles for local recycling or shipment to nearby facilities for use in the manufacture of recycled content products.

Steam and hot water processing provides commodity sanitizing and paper pulping which facilitates easy and efficient mixed paper fiber, film plastics and traditional recycled commodity separation. Novel use of carefully sized (50 mm-100 mm) pre-screening equipment facilitates separation of food waste rich organics and glass cullet with MSW derived undersized screenings for composting or digestion and glass recovery while maximizing downstream pre-steam processing separations of ferrous metals, batteries e-waste, and textiles. Sanitized recovery of fully pulped mixed paper and paperboard fiber, and post-consumer film packaging, plastic and non-ferrous metal containers follows steam processing. A dry-cleaning system provides removal of water and remaining contamination after steam processing and fiber separations. The dryer in conjunction with hot water and steam processing of plastics provides extensive de-labeling, de-inking and contamination removal and eliminates highly cost-prohibitive water washing, which is possibly the most capital and operationally cost intensive part of dirty MRFs targeting high value mechanical recycling of post-consumer plastics.

The system facilitates maximum landfill diversion and decarbonization as well as integration with future recycling technologies while taking advantage of existing MSW collection and landfill infrastructure. The system lowers landfill costs including but not limited to waste placement and interim daily cover, new cell design, permitting, and construction frequency, landfill taxes, mandated post-closure care as well as significant reductions in nauseous odor, hazardous leachate, wind-blown litter and vermin issues.

The system is capable of processing a true mixed waste stream and can efficiently separate and recover materials for recycling such as film plastics and textiles which are considered contamination and are banned by most curbside MRFs and destined for non-sustainable combustion applications. This system uses air/density separation equipment after pulped fiber separation to recover massive quantities of film plastic with negligible contamination. Use of such density separations technology for highly efficient film separation is facilitated by upstream pulping and screen separation of paper and paperboard. The removal of film plastics, paper and paperboard upstream of eddy current non-ferrous metals separations and NIR optical sort of rigid plastics results in a massive increase in equipment efficiency and reduces the number of metals and plastic separation units necessary for removal of these traditional recycle commodities.

The efficient and fully automated separation of mixed film from household MSW after steam pulping and fiber recovery, if employed today, would by far, represent the single highest value commodity recovery of all. This is a transformative advancement in recycling as it provides massive quantities of lower-value post-consumer plastics to facilitate reuse by advanced plastics recycling facilities and allows for further development of recycling of these plastics instead of incinerating or landfilling these plastics. Post-consumer film plastic is currently considered to be of very low or zero value once mixed with municipal waste streams and is viewed as detrimental to curbside recycling even when source separated. Consequently, film plastics represent far and away the largest fraction of all post-consumer plastics and yet are landfilled at an astounding ratio of up to 10% of all MSW landfill waste in the United States

The combined benefits of this system will be unparalleled in modern MSW landfill operations and post-consumer recycling as each category of commodity recovered has its own positive environmental impact as estimated in metric tons of avoided carbon emissions as recovered low carbon intensive recycled commodities replace virgin feeds for recycled plastic product manufacturing in nearby markets.

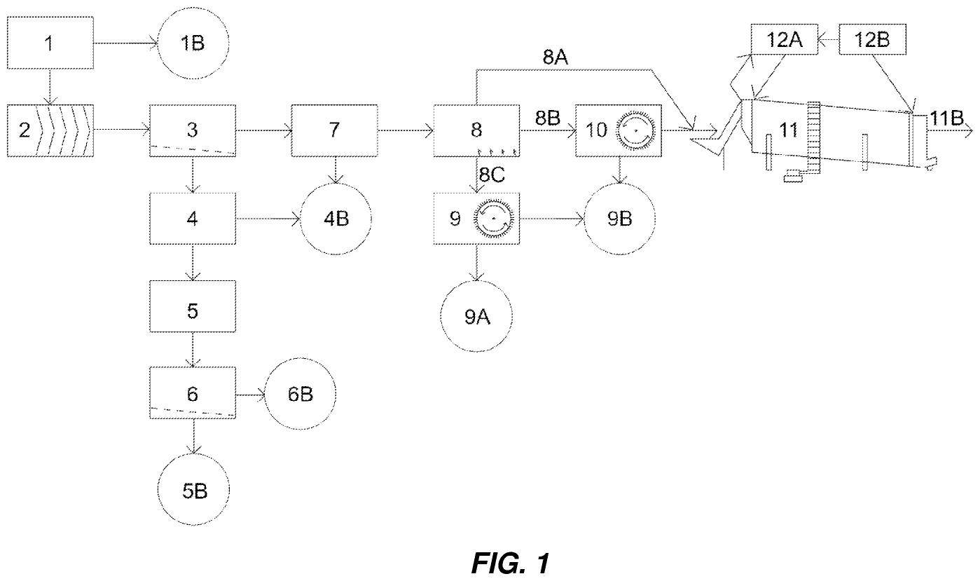

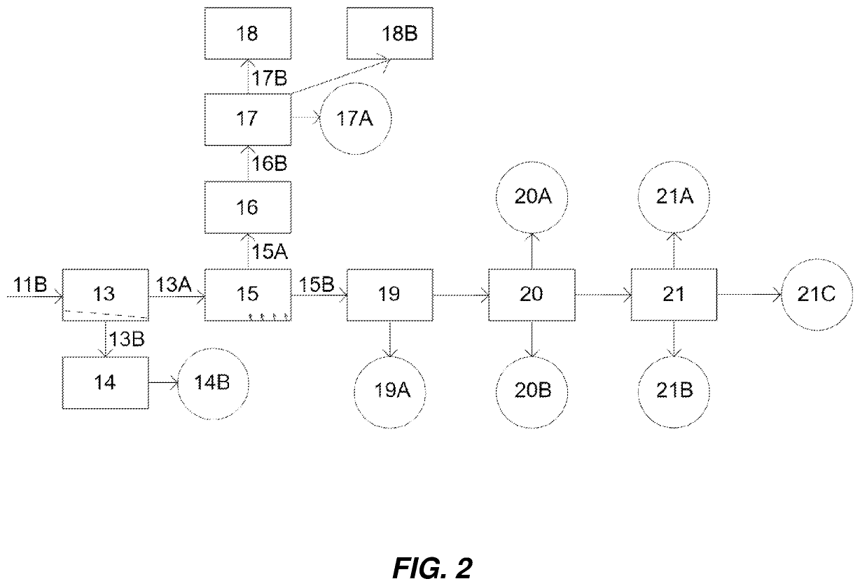

FIGS. 1 and 2 show a process flow diagram for the waste processing system. The process is discussed with reference to an incoming amount of about 50 metric tons (50,000 kg) of mixed waste from residential or commercial origin. The various material flow rates discussed herein are example flow rates which are expected to occur at the different steps throughout the system based on the average composition of waste from residential waste collection. (1) Tip Floor—This is where trucks filled with MSW from single family housing are unloaded directly onto the floor. Although this material originates at single family residences and typically carried to the street in covered 96-gallon wheeled carts, there is still a need for visual inspection and removal of non-recyclable materials such as propane bottles, small furniture, appliances or other white goods, tires, dimensional lumber, manufactured products and other non-MSW compliant waste by grapple, front end loader or other mechanical means. Typically, about 1 ton per hour is rejected (at 1B) and about 49 ton per hour is processed through the waste processing system beginning with the shredder (2).

(2) Low speed, High Torque Shredder—The shredder provides consistent metering rates selected for optimal and efficient operation of all downstream separations and conveyance systems. Pre-shredding size is also variable and shredding to a more consistent size is highly beneficial to efficient downstream Oversize Separations identified in FIG. 1, Nos 9 and 10 and NIR Optical sort identified in FIG. 2 No 17. The shredder (2) shreds to a size between about 20 cm and about 40 cm. Shredding too small can result in highly absorbent materials bypassing Oversize Separators and unnecessarily entering hot water and steam processing vessel while absence of shredding can result in textiles, film plastics, or long objects such as rope or extension cords which are large or long enough to wrap around and foul Oversize Separators. Optimally sized film increases NIR Sort system efficiency. Initial shredder operation also opens all bags for necessary screening access, crushes glass for early separation to avoid contamination of mixed paper fibers and breaks apart battery and e-waste which may be fully encased in metal or rigid plastic materials. Without shredding, encapsulated batteries could otherwise avoid early magnetic separation, creating significant risk associated with auto ignition of lithium in damaged batteries much farther into downstream processing systems. The system allows for elimination of Hand Sort Stations, Robotic Sorting, Textiles, and Wood Separations, and the risks and costs associated with these systems. The size reduction provided by the shredder supports the efficient, cost effective operation of the downstream processing and separation devices.

(3) Initial Screening System of the MSW stream by selection of aggressive screening equipment ensures necessary size reduction of most glass (other than Champaigne bottles), and is sequenced immediately following shredding to separate food waste rich organics and crushed glass and other inorganic fines for composting and subsequent glass separation and recycling. The screen separator (3) uses a screen size which is between about 5 cm and about 10 cm. Food waste passes through the screen with the undersized cut, and the oversize cut is sized to capture smaller aluminum and rigid plastic containers among other post-consumer commodities. Typically, about 18.1 tons per hour pass through the screen (3) as the small size fraction and about 30.9 tons per hour exit the screen (3) as the large size fraction.

(4) and (7) Magnetic separations systems are used to separate small ferrous metal fines including small household batteries from composting bound organics fines. Typically, the magnetic separator (4) separates about 0.5 tons per hour of ferrous materials (4B). Efficient and low-cost magnetic separation (7) is also used to remove ferrous materials from screened oversized materials such as coat hangers, partially crushed metal manufactured goods and other ferrous materials that can otherwise become entangled with textiles and/or film plastics reducing downstream separations efficiency and rendering tangled metals and other recyclable commodities worthless and destined for landfill rather than recycling within multiple sustainable commodity recycling streams. Typically, the magnetic separator (7) separates about 1.5 tons per hour of ferrous materials (4B) and outputs a stream of about 29.4 tons per hour of mixed waste.

(5) Composting Operations are used to process the fine material that passes through the magnetic separator (4). Composting typically results in a volume reduction of up to 80% of the material stream. The composting facility may be either co-located or at a nearby location offering necessary acreage and permitting acceptance. A properly managed composting operation will provide safe, responsible and reliable volume reduction of screened organics. The composting (6) receives about 17.6 tons per hour from the magnetic separator (4) and outputs about 5 tons per hour on average. The output stream often includes compost as well as some crushed glass. After composting is complete, a screen separator (6) is preferably used to separate the composted material to about 3 tons per hour of compost (5B) and about 2 tons per hour of glass (6B). The screen separator (6) uses a screen size which is between about 2.5 cm and about 5 cm. Composting provides a significant reduction in the volume of MSW derived organics and the composted material has excellent value for use as inert interim daily cover to reduce landfill host operating expenses and further increase landfill diversion rates. Should compost associated with this system qualify for interim daily cover as proposed, this would easily ensure daily landfill diversion rates for materials passing through this steam based constant flow recycling system in excess of 65% and still over 55% diversion should compost be responsibly landfilled.

(8) A Three-Cut Air/Density Separator receives mixed waste from the magnetic separator (7) and is used to separate the waste into light, medium, and heavy cuts. The mixed waste material is typically fed off the end of a conveyor belt and falls over air jets producing an upward stream of air which is tuned to push the light film plastics and paper upward and above the remaining recyclable material stream. The light two-dimensional film plastics and paper are then captured by a vacuum which sucks these materials into an overhead duct which conveys the material for further processing. The Air Density Separator separates the heavier material into medium and heavy cuts which then fall onto separate transport ducts or conveyor belts for separation of textiles. The three-cut separations system greatly reduces materials fed to the downstream rotopulper by as much as 50%, massively increasing the pulping system capacity to process targeted paper and paperboard for pulping of mixed paper fiber and processing of film plastics, rigid plastics, and aluminum containers by sanitizing, de-labeling and deinking and removing of the majority of contamination. Reduction of material fed to the rotopulper significantly reduces water and electricity consumption per ton of total MSW stream processed. Textile recovery is also reduced as two separate and much smaller streams containing shredded clothing, bedding and other textiles are more efficiently separated due to much lower system throughput of each split stream containing textiles. The three-cut separator system (8) is capable of efficient short term separation of two dimensional plastic film packaging and two dimensional paper in the lights cut. The Density Separator (8) typically produces about 10 tons per hour of light paper and film plastics (8A) which is then fed to the Rotopulper (11). The Density Separator (8) typically produces a middle density cut (8B) containing non-ferrous and rigid plastics containers, paperboard, magazines and other dense paper products, which is about 5.4 tons per hour and is also fed to the rotopulper (11) upon interim removal of textiles. The Density Separator (8) typically produces a high density cut (8C) which is about 14 tons per hour. This heavies cut (8C) is typically this systems largest initial residuals stream. This stream may be targeted for future separations and recycling opportunities as they arise.

(9) and (10) Oversize Separators are used to process the high density stream (8C) and medium density stream (8B). These Oversize Separators typically utilize a rotating cylindrical drum, configured perpendicular to, and several inches over the advancing, commodity rich, but volume reduced recycling streams associated with the medium density and heavy density streams exiting the Three Cut Density Separator. The drum is fitted with spikes which rotate in the opposite direction of material flow, snagging the flexible, two-dimensional textiles as the size reduced textiles pass under the counter rotating drum. The rotating drum spikes then carry the textiles over the top of the drum, and retract on the back side of its rotation to release the textiles (9B) onto conveyors for transport to a collection location. The medium density cut (8b) is processed by separator (10) and typically produces about 2 tons per hour of textiles (9B). About 3.4 tons per hour of material exits the separator (10) and is fed to the Rotopulper (11) for steam processing along with the film and paper recovered within the Density Separator light fraction (8A). The high density cut (8C) is processed by separator (9) and typically produces about 2 tons per hour of textiles and about 12 tons per hour of residuals (9A). Typically, about 4 tons per hour of textiles (9B) are produced by separators (9) and (10). Removal of textiles is highly important to avoid saturation of highly absorbent textiles during steam processing in the Rotopulper (11). Processing of textiles in the Rotopulper largely eliminates recyclability of cotton and polyester textiles while greatly increasing the weight of all textiles and results in significant increases in steam processing utilities consumption and residual disposal costs.

(11) Rotopulper—Medium density material from the separator (10) and light density material (8A) from the density separator (8) are fed into a Constant Flow Steam Processing Vessel (11). This horizontal, constant-flow steam drying vessel is capable of containing saturated steam with mechanical seals during constant flow processing in order to maintain a variable range of necessary operating temperatures and uses variable pitch and rotational speed controls to facilitate adjustment of agitation and retention times to facilitate optimal processing results. About 13.4 tons per hour of material is fed into the Rotary Steam Processing Equipment (11). In the example Rotary Steam Processor, the waste stream is fed up an inclined feed conveyor and is saturated with hot water and delivered into a horizontal, enclosed, insulated, and rotating constant flow steam pulping vessel which may often be between about 2 meters and about 5 meters in diameter and anywhere between about 10 meters and about 25 or about 30 meters long. The pulping vessel primarily breaks saturated paper and paperboard products down into fiber by maintaining an elevated temperature in the pulping vessel for between 40 and 80 minutes by saturated steam to a temperature of between 150 degrees F. and 212 degrees F. The pulping vessel additionally provides agitation necessary for pulping by utilizing lift plates in the rotating vessel to repeatedly lift and drop the material stream for the aforementioned duration, which is dictated by vessels variable rotational speed and variable downward slope as gravity moves the material forward in this lift and drop vessel design. The Rotary Steam processor is also advantageous in removing labels and inks from plastics and recyclable containers and generally cleaning the recyclable materials.

(12) Saturated Steam & Hot Water System. The steam and hot water system may use a passive venturi system at the inlet end of the rotary pulping vessel to draw countercurrent flow of saturated steam through the constant flow pulping vessel into a system hot water heater vessel, to assist in maintaining consistent Rotopulper vessel temperature optimal for steam processing and also to reduce water and utilities consumption by reuse of heat in excess steam recovered and use of steam condensate for hot water addition as post-consumer commodities enter the Rotopulper vessel. The steam system 12 may include a hot water condenser (12A) that receives steam from the inlet of the rotopulper (11) to create a counter current flow of steam and which also delivers hot water to the inlet of the rotopulper (11). The condenser (12A) typically receives about 0.5 tons of steam per hour from the rotopulper (11) an delivers about 3 tons per hour of hot water to the rotopulper (11). The steam system also includes a boiler (12B) that provides heat and steam to the condenser (12A) and which also delivers about 3.5 tons per hour of saturated steam to the outlet end of the rotopulper (11). Including the added moisture, about 19.4 tons per hour of material (11B) exits the rotary steam processor (11).

(13) Mixed Paper Fiber Screen Separation. A screen separator is used to separate paper pulp from the other materials (11B) exiting the rotary steam processor (11). The screen separator (13) typically uses a screen size ranging from about 1 cm to about 3 cm to separate fully pulped mixed paper fiber, where pre-steam processing separations have largely removed materials fines which would have contaminated the recovered mixed paper fiber. Materials previously removed by upstream equipment to avoid contamination of recovered mixed paper fiber recovered include food waste, pet waste, glass and other silicates. Glass is particularly important to separate prior to paper fiber pulping due to its abrasive nature once embedded in mixed paper fiber during the steam processing operations. Steam pulping and subsequent screening recovery of all two-dimensional paper products facilitates fully automated, low-cost and efficient two-dimensional film plastics separations from the screened overs by downstream equipment; allowing for recovery of film plastics and other plastics which are not normally recoverable from mixed waste for recycling. The screen typically produces about 9.4 tons per hour of larger materials (13A) and about 10 tons per hour of wet paper pulp (13B). The wet paper pump (13B) is typically about 70 percent water; having about 3 tons per hour of paper pulp and about 7 tons per hour of water.

(14) Mixed Paper Fiber Screw Press Dewatering—Water is recovered from the mixed paper fiber such as with a screw press. The water may be returned to the steam system (12) or used for other purposes. A screw press typically reduces fully pulped mixed paper and paperboard fiber moisture content to about 50% and produces a paper pulp (14B) with minimal inorganic contamination due to carefully sequenced pre-steam processing separations. Waste heat drying may also be used to further dry the recovered mixed paper fiber, particularly if transportation cost can be significantly reduced and/or should end market mixed paper fiber specifications dictate lower moisture content.

(15) Two-Cut Density Separations—Large material exiting the screen separator (13) is fed into an air knife gravity/density separator (15). Typically, the material is fed off the end of a conveyor belt and falls over air jets producing an upward stream of air which is tuned to push the light film plastics upward and above the remaining recyclable material stream. The light two-dimensional film plastics are then captured by a vacuum which sucks the film into an overhead duct which conveys the material for further processing or collection. Of the material fed into the screen separator (13), about 6 tons per hour of light plastics (15A) are recovered in the light materials outlet stream from the separator (15). About 3.4 tons per hour of heavy materials (15B) fall downwardly and are collected onto another belt which feeds downstream Eddy Current non-ferrous metals separation equipment and NIR plastics separations equipment. One of the many advantages of the recycling system is the ability of this system to separate and efficiently recover massive quantities of film plastics contained in typical MSW without significant labor. The lights cut (15A) of this air density-based separation system will be almost exclusively two-dimensional film plastics as nearly all two-dimensional paper has been steam pulped and screen separated unless coated with wax or plastic film. Coated papers will have absorbed sufficient water during the steam pulping operations to exit with the separator heavy fraction and are disposed as residuals or potentially shredded for composting.

(16) Light materials from the density separator (15) are fed into a Flexible Film Air Wash/Dryer. The air wash dryer uses hot air to dry the film plastics and to also remove any remaining organic or inorganic contamination from the film plastics Meeting plastic film specifications for Post Consumer Recycling (PCR) plastics in many if not most PCR markets results in premium pricing at significantly lower cost for this voluminous post-consumer category of plastics. Such lower cost are primarily enabled by combining long duration, aggressive steam and hot water processing with efficient dry wash systems to meet and exceed post-consumer plastics market specifications and thus avoid extremely high capital cost, operational costs, and non-sustainable water consumption associated with water wash systems designed specifically for film plastic wash.

Dried plastics (16B) from the air wash are delivered to a NIR Mixed Film Plastics Optical Sort separator (17). The Near Infrared (NIR) Optical Sort separator is used to initially recover PVC and metalized film which is undesirable to most recycled film plastics users. Typically, about 0.3 tons per hour of PVC or metallized film (17A) are removed and about 5.5 tons per hour of other film plastics (17B) are produced. Once undesirable types of film plastics are separated, remaining mixed plastics film may simply be baled (18) for sale as mixed film to meet specifications for advanced thermochemical conversion technology applications or may be further processed with a NIR Optical sort separator (18B) by polymer type to create higher film commodity price points for specific polymer types which are in high demand for mechanical recycling, such as polyethylene. Separated plastics may also be optionally melt filtered or densified before delivery for potentially higher end market values.

About 3.4 tons per hour of heavy materials from the density separator (15) are delivered to an Eddy Current separator (19). The eddy current separator (19) recovers aluminum and other non-ferrous metals from the heavy cut materials stream (15B) from the density separator (15). About 0.3 tons per hour of non-ferrous metals (19A) are separated by the eddy current separator (19). Carefully sequenced upstream separations result in efficient separation of this most environmentally important commodity recovery on a pound for pound basis. The carbon emissions avoidance associated with smelting of post-consumer aluminum containers for recycling versus overseas mining, ore processing, and ocean transport for production of aluminum is unparalleled.

About 3.1 tons per hour of residual material from the eddy current separator (19) are delivered to NIR (Near Infrared) Rigid Plastics Optical Sort Systems (20) and (21).—Multiple instances of NIR Optical sort separators for rigid plastics separation may be used for separating various materials such as PET, HDPE Natural, HDPE Colored, and Polypropylene, which are the most commonly targeted rigid plastics for reuse. One or more of the NIR optical sorting machines may be used as necessary to separate the desired throughput and number of types of plastics. As configured, the first NIR separation machine (20) typically produces about 0.5 tons per hour of PET (20A) and about 0.3 tons per hour of PVC (20B) and passes about 2.3 tons per hour of material to the second NIR separation machine (21). The second NIR separation machine (21) typically produces about 1 ton per hour of HDPE (21A) and about 0.5 tons per hour of polypropylene and polystyrene (21B) and produces about 0.8 tons per hour of residual material (21C).

The MSW processing system described herein allows for separation of nearly all recyclable materials from landfill bound waste without requiring any initial separation or handling of the materials by facility staff by hand. The system focuses upon automation and recovers most recyclable materials in usable form and minimizes the amount of material entering the landfill. In comparison, current recycling programs cannot process many mixtures of recyclable materials and require a significant amount of presorting by consumers before placing materials into recycling collection bins. The high cost, restrictive, complex recoverable commodity requirements, and other burdens associated with current recycling programs has led to their poor adoption and poor use/compliance by the population as a whole. The present system eliminates most of the obstacles which are part of current recycling systems and significantly improves both the efficiency and quantity of recyclable commodity recovery. The system can advantageously create and remove steam pulped paper and paperboard fiber in an efficient pulping and screening stem and also efficiently remove film plastics in a manner which provides clean and reusable material. The steam rotary pulping system uses a venturi system to draw steam from the inlet end while introducing steam at the outlet end to create countercurrent flow in the rotary vessel. The placement and sizing of the initial shredding and the initial screening is effective in conditioning a garbage stream which is largely free of organic waste and which is effectively separated by the sequence of downstream equipment. The three cut up-flow density separation at process (8) is effective in removing residuals from valuable plastics, non-ferrous metals, paper and film plastics as well as preparing these for removal of textiles and further separation. The three cut density separation and the subsequent textiles removal separators effectively remove nearly everything from the waste stream that does not benefit from steam processing of that may impede steam processing and further separation. Density separation using upwardly moving air following the steam rotary pulping vessel effective separates film plastics that create a valuable commodity. These film plastics were not previously handled by recycling systems are generally not permitted in source separated recycling collection systems.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example dimensions, materials, values, times, etc., are provided for explanation purposes and that other values may also be employed in other examples in accordance with the teachings of the present invention.

What is claimed is:

1. A waste processing system for recovering recyclable materials from mixed waste garbage comprising:
a shredder configured to shred incoming mixed waste garbage;
a first screen separator configured to receive material from the shredder and to separate food waste rich organic materials from the mixed waste garbage;
a second separation system configured to receive material from the first separator and to separate paper, film plastics, and rigid plastics, from textiles and residual garbage material;
a steam rotary pulping machine configured to receive paper, film plastics, and rigid plastics second separation system and to reduce paper based materials to wet paper pulp through mechanical agitation and the addition of steam;
wherein wet paper pulp is separated from the plastic film and the rigid plastics; and
a first density separator configured to use upwardly moving air to separate film plastics from rigid plastics.

2. The waste processing system of claim 1, wherein the shredder is configured to shred incoming mixed stream garbage to a size between about 20 cm and about 40 cm and wherein the first separator comprises a first separation screen having an opening size which is between about 5 cm and about 10 cm.

3. The waste processing system of claim 1, further comprising a third screen separator configured to receive material exiting the steam rotary pulping machine to thereby separate wet paper pulp from the plastic film and the rigid plastics.

4. The waste processing system of claim 3, further comprising an eddy current separator configured to receive materials exiting the third screen separator and separate non-ferrous metals from other materials exiting the third separator.

5. The waste processing system of claim 1, further comprising an air washing machine configured to air wash and air dry the film plastics exiting the first density separator.

6. The waste processing system of claim 1, wherein the second separation system comprises:
a second density separator configured to use upwardly moving air to separate incoming mixed waste garbage into:
a light fraction comprising paper and film plastics;
a medium fraction comprising textiles, rigid plastics and non-ferrous metals; and
a heavy fraction comprising textiles and waste residuals; and
a first textiles separator configured to remove textiles from the medium fraction.

7. The waste processing system of claim 6, wherein, after removal of textiles, the medium fraction and the light fraction are fed into the steam rotary pulping machine for processing by the steam rotary pulping machine.

8. The waste processing system of claim 1, further comprising a magnetic separator configured to remove ferrous materials from the mixed waste garbage, wherein the magnetic separator is disposed between the first screen separator and the second separation system.

9. A waste processing system for recovering recyclable materials from mixed stream garbage comprising:
a first screen separator configured to separate food rich waste from the mixed waste garbage;
a second separation system configured to remove textiles from the mixed waste garbage;
a steam rotary pulping machine configured to process paper, plastic film, and rigid plastics from the mixed stream garbage after the mixed stream garbage has passed through the first separator and the second separation system to reduce paper based materials to wet paper pulp through mechanical agitation and the addition of steam;
wherein wet paper pulp is separated from the plastic film and the rigid plastics; and
a downstream density separator configured to separate film plastics from rigid plastics by using upwardly moving air.

10. The waste processing system of claim 9, wherein the system comprises a shredder configured to shred incoming mixed stream garbage to a size between about 20 cm and about 40 cm before the mixed stream garbage enters the first separator.

11. The waste processing system of claim 9, wherein the first screen separator comprises a first separation screen having an opening size which is between about 5 cm and about 10 cm.

12. The waste processing system of claim 9, further comprising a third screen separator configured to receive material exiting the steam rotary pulping machine to thereby separate wet paper pulp from the plastic film and the rigid plastics.

13. The waste processing system of claim 12, wherein the third screen separator comprises a third separation screen having an opening size which is between about 1 cm and about 3 cm.

14. The waste processing system of claim 12, further comprising an eddy current separator configured to receive materials exiting the third screen separator and separate non-ferrous metals from the materials exiting the third screen separator.

15. The waste processing system of claim 9, further comprising an air washing machine configured to air wash and air dry the film plastics exiting the downstream density separator.

16. The waste processing system of claim 9, wherein the second separation system comprises:
an upstream density separator configured to use upwardly moving air to separate incoming mixed waste garbage into:
a light fraction comprising paper and film plastics;
a medium fraction comprising textiles, rigid plastics and non-ferrous metals; and
a heavy fraction comprising textiles and waste residuals; and
a first textiles separator configured to remove textiles from the medium fraction.

17. The waste processing system of claim 16, wherein the first textiles separator comprises an overhead drum with selectively extending spikes configured to remove textiles from a material stream.

18. The waste processing system of claim 16, wherein, after removal of textiles, the medium fraction and the light fraction are fed into the steam rotary pulping machine for processing by the steam rotary pulping machine.

19. The waste processing system of claim 9, further comprising a magnetic separator configured to remove ferrous materials from the mixed waste garbage, wherein the magnetic separator is disposed between the first screen separator and the second separation system.

20. The waste processing system of claim 9, further comprising a steam generation system configured to:
introduce steam into an outlet end of the steam rotary pulping machine;
withdraw steam from an inlet end of the steam rotary pulping machine; and
introduce heated water into an inlet end of the steam rotary pulping machine.
